(19) United States
(12) Patent Application Publication
(10) Pub. No.: US 2017/0052666 A1
(43) Pub. Date: Feb. 23, 2017

(54) METHODS AND APPARATUS FOR PROVIDING PERSONALIZED CONTROLLING FOR VEHICLE

(71) Applicants: Peggy WANG, Pudong District, Shanghai (CN); GM GLOBAL TECHNOLOGY OPERATIONS LLC, Detroit, MI (US)

(72) Inventors: Peggy Wang, Shanghai (CN); Jianfeng Wang, Shanghai (CN); William Otto, Warren, MI (US)

(73) Assignee: GM GLOBAL TECHNOLOGY OPERATION LLC, Detroit, MI (US)

(21) Appl. No.: 15/118,690

(22) PCT Filed: Mar. 5, 2014
(86) PCT No.: PCT/CN2014/072885

§ 371 Date: Aug. 12, 2016

(51) Int. Cl. G06F 3/0484; G06F 3/0482; B60K 35/00

(52) U.S. Cl. CPC G06F 3/0484; B60K 35/00; G06F 3/0482; B60K 2350/1016; B60K 2350/1032; B60K 2350/1096; B60K 2350/352

(57) ABSTRACT

A method for providing customized infotainment options to a vehicle user. The method includes receiving, by a system having a processor, using a data mining module of a learning interface, and from a control panel, a first control signal including an information data set. The method also includes storing, by the system, using the mining module, the information data set to a memory, and identifying, by the system, using the mining module, reoccurring data segments of the information data set. The method further includes generating, by the system, using the mining module, a preference data set including the reoccurring data segments, and processing, by the system, using an adaptive module of the interface, the preference data set, yielding option data. And the method includes sending, by the system, using the adaptive module, via a second control signal, the option data to the control panel for presentation to the vehicle user.

### TECHNICAL FIELD

The present technology relates to software that relates to a personalized integrated user experience during vehicle functions. More specifically, the technology provides personalized controlling using a vehicle control panel.

### BACKGROUND

Information-based media content and programming that includes entertainment have been integrated into vehicles in order to enhance a driver and/or passenger experience while inside of the vehicle. This combination of media and entertainment is known as infotainment. Infotainment systems are typically operated through the use of applications, which can be pre-integrated to an onboard computer by manufacturers or downloaded through a human-machine interface (HMI).

In many vehicle designs, HMI interactions occur at a center stack of a vehicle, located in a space between a vehicle operator seat and a vehicle passenger seat, beginning at the dashboard and extending to the gearshift and often to a center console. The controls for infotainment applications (infotainment controls) often include a variety of input components including hard buttons and knobs and/or soft buttons on a touch-sensitive screen. By way of the infotainment controls, a user can control the input/output of audio and multi-media content, communication, or general vehicle status information, for instance.

While driving, if a vehicle operator wants to adjust a setting within the vehicle, e.g., change radio channel, pause presently-playing music, or select a pre-stored destination within a navigation system, he has to reach to the infotainment controls located on the center stack, which among other safety concerns, requires him to take at least one hand off the steering wheel to reach the center stack and/or take his eyes off the road.

Vehicle manufacturers have tried to alleviate safety concerns associated with vehicle operator interaction with infotainment systems. Some infotainment systems integrate controls such as a receive/end telephone call button on the vehicle steering wheel for easy operator accessibility. However, the steering wheel controls do not allow the vehicle operator to select infotainment options from the control stack that are not currently integrated on the steering wheel.

### SUMMARY

A need exists for vehicle operators to have convenient access to infotainment applications while operating a vehicle. The present disclosure relates to systems and methods for providing personalized infotainment options within a vehicle.

In one aspect, the present technology includes methods for providing customized infotainment options to a vehicle user including (i) receiving, using a data mining module, from a control panel, a first control signal including an information data set, (ii) storing, using the data mining module, the information data set to a memory, (iii) identifying, using the data mining module, reoccurring data segments of the information data set, (iv) generating, using the data mining module, a preference data set including the reoccurring data segments, (v) processing, using an adaptive module, the preference data set, yielding option data, and (vi) applying, using the adaptive module, via a second control signal, the option data to the control panel for presentation to the vehicle user.

In some embodiments the method further comprising sending, using the adaptive module, on the control panel an output comprising the preference data set.

In some embodiments the methods also include receiving, by the system, using the data mining module, from a human-machine interface (HMI), a second control signal including a software data set.

In some embodiments, the receiving the information data set, storing the information data set, identifying the reoccurring data segments, or receiving the software data set are generally continuously with respect to various data sets received during a time in which a vehicle is operated.

In another aspects, the present technology includes computer-readable storage devices comprising instructions including: (i) receiving, using a data mining module, from a control panel, a first control signal including an information data set, (ii) storing, using the data mining module, the information data set to a memory, (iii) identifying, using the data mining module, reoccurring data segments of the information data set, (iv) generating, using the data mining module, a preference data set including the reoccurring data segments, (v) processing, using an adaptive module of the learning interface, the preference data set, yielding option data; and (vi) sending, using the adaptive module, via a second control signal, the option data to the control panel for presentation to the vehicle user.

In some embodiments the instructions further include sending, by the adaptive module, on the control panel an output comprising the preference data set.

In some embodiments, the receiving the information data set, storing the information data set, identifying the reoccurring data segments, or receiving the software data set are generally continuously with respect to various data sets received during a time in which a vehicle is operated.

Other aspects of the present technology will be in part apparent and in part pointed out hereinafter.

### DESCRIPTION OF THE DRAWINGS

FIG. 1 illustrates schematically a panel system for implementing personalized controlling in accordance with an exemplary embodiment.

FIG. 2 illustrates an embodiment for setting personalized control features of the panel system of FIG. 1

FIG. 3 illustrates an embodiment for recalling personalized control features of the panel system of FIG. 1.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, illustrative, and similar terms, refer expansively to embodiments that serve as an illustration, specimen, model or pattern.

Descriptions are to be considered broadly, within the spirit of the description. For example, references to connections between any two parts herein are intended to encompass the two parts being connected directly or indirectly to each other. As another example, a single component described herein, such as in connection with one or more functions, is to be interpreted to cover embodiments in which more than one component is used instead to perform the function(s). And vice versa—i.e., descriptions of multiple components described herein in connection with one or more functions are to be interpreted to cover embodiments in which a single component performs the function(s).

In some instances, well-known components, systems, materials, or methods have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

While the present technology is described primarily in connection with a vehicle in the form of an automobile, it is contemplated that the technology can be implemented in connection with other vehicles, such as marine craft and air craft.

### I. CONTROL PANEL SYSTEM

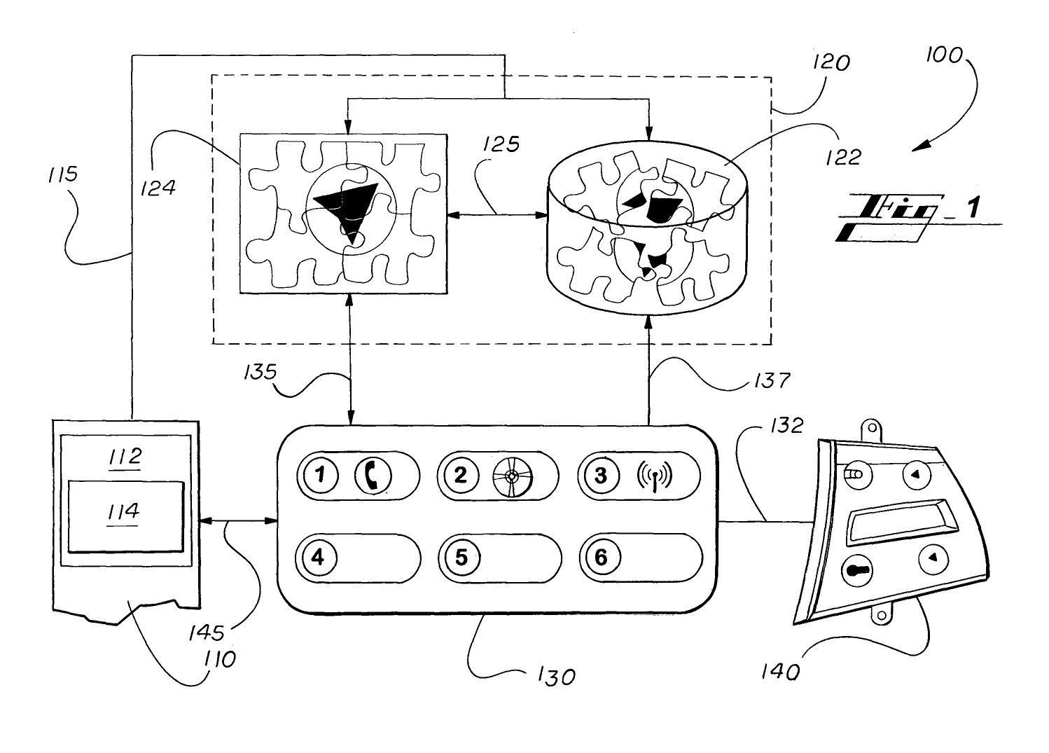

### FIG. 1

Now turning to the figures, and more particularly the first figure, FIG. 1 illustrates a panel system 100 for implementing personalized controlling in accordance with an exemplary embodiment. The panel system 100 comprises (1) a HMI module 110, (2) a setting module 120, and (3) a center stack control panel 130, hereinafter control panel 130. In some embodiments, the panel system 100 may include a user proximity control panel 140, hereinafter proximity control 140.

The HMI module 110 presents, to the vehicle operator, by way of the control panel 130, visual representations of processed data. The data or other indication of the representations to be displayed are communicated to the control panel 130 from the HMI module 110 by a control signal 145. These features are described more below. The HMI module 110 may include an electronic control unit (ECU) 112 and software 114.

Many HMI interactions include those using the infotainment applications for receiving and providing infotainment. The HMI module 110 is thus equipped with an ability to communicate, to an in-vehicle user, information related to the infotainment applications. Example infotainment information that can be transmitted includes, but is not limited to, phone calls (e.g., contacts, dial, recent call, favorite), navigation (e.g., point of interest, address book, recent destinations, current location), wireless connection (e.g., Bluetooth link, internet applications), and audio options (e.g., AM/FM radio, compact disks, auxiliary).

The functionality of the above applications is accomplished by software updates provided by the HMI module 110 to the control panel and/or the proximity control 140. As such, the HMI module 110 may transmit to the control panel and/or the proximity control 140 task specific infotainment applications (e.g., phone call to a certain contact, a specific FM radio channel, a specified temperature, or a specific application).

The ECU 112 controls the electrical system(s) within the HMI module 110. The ECU 112 may be integrated to work with other ECUs within the vehicle for safety or another purpose. For example, the ECU 112 may integrate with a brake control module within the vehicle to trigger a response for deceleration (e.g., breaking) in response to a potential safety incident. In some embodiments, the software 114 may be embedded as seen in FIG. 1.

The ECU 112 may contain one or more of the following components (not shown in detail): (i) a core, including a microcontroller, microprocessor, programmable logic controller (PLC), complex programmable logic device (CPLD), field-programmable gate array (FPGA), or the like; (ii) a memory for storing data such as static random access memory, electrically erasable programmable read only memory, or the like; (iii) inputs for power delivery and analog/digital information; (iv) outputs for drivers or logic; and (v) communication links to allow devices (or their microcontrollers) to communicate with one another without a host computer system.

The core may be developed through use of code libraries, static analysis tools, software, hardware, firmware, or the like. Any use of hardware or firmware includes a degree of flexibility and high-performance available from an FPGA, combining the benefits of single-purpose and general-purpose systems. It will be apparent to a person skilled in the relevant art how the present technology can be implemented using one or more other computer systems and/or computer architectures.

The software 114, typically embedded in the ECU 112, may include a supervisor control and data acquisition (SCADA) or similar control system (not shown in detail). The HMI module 110 is linked to the databases and programs of the software 114, to provide trending, diagnostic data, and management information such as scheduled maintenance.

The ECU 112 is responsible for transmitting a control signal 115 to the setting module 120. Information transmitted by the control signal 115 may include logic and other terms as determined by the software 114.

The setting module 120 is a learning interface used to assign features for each user inputs presented by way of the control panel 130 and/or the proximity control 140. The setting module 120 is as an interface that can learn to interpret user input data (represented by reference numbers 135 and 137) and software input data (represented by reference number 115) over a period of time (e.g., one week). Learning user and software input data may be accomplished through any variety of processes, methods, algorithms, or the like. By learning to interpret the user and software input data, the setting module 120 may suggest future user preferences, described below.

The setting module 120 includes an adaptive module 124 and a data mining module 122, which function together allowing the setting module 120 to receive information (e.g., gathered by the data mining module 122 from the control panel 130) and implement changes (e.g., programming from the adaptive module 124 conveyed to the control panel 130 to allow user input data).

The control signal 115, mentioned above, is generated by a processor within the ECU 112 and transmitted to the setting module 120 where the control signal 115 is received by the adaptive module 124 and/or the data mining module 122. The control signal 115 as stated above may include logic and other terms as determined by the software 114 (e.g., system date and time).

The data mining module 122 allows filtering of user input data including (i) past preset interactions (e.g., factory settings), (ii) past vehicle operator/passenger interactions (e.g., user interface on the control panel 130), and (iii) future preset interactions (e.g., system updates).

The data mining module 122 may store user data to a memory (not shown) until enough information is gathered to generate the reoccurring data segments needed to form a suggested feature. The memory can be those similar to the types of memory described in association with the ECU 112 and stored either internal or external to the data mining module 122.

The data mining module 122 determines what features to suggest for the control panel 130 and/or the proximity control 140. The more information that is received by the data mining module 122, the more in tune the data mining module 122 becomes with the habits of the vehicle operator (or other user). For example, over a period of time (e.g., one week), the data mining module 122 will receive sets of data which detail vehicle operator inputs (e.g., telephone calls, navigation locations, etc.) as well as software data imported from the HMI module 110 (e.g., time of day, day of the week, etc.). The combination of user inputs and imported software data allows the data mining module 122 to find reoccurring data segments (represented by separated puzzle pieces within data mining module 122). These reoccurring data segments are used to generate suggested features that are processed by the adaptive module 124 (represented by joined puzzle pieces within the adaptive module 124). The suggested features processed by the adaptive module 124 are then presented to the control panel 130 for the vehicle user.

In some embodiments, personalized preferences may change depending on user inputs. For example, the data mining module 122 may generate one set of suggested features for a workday and another set of suggested features for a non workday. As another example, suggested features proposed during working hours may include suggestions such as calling an office number or navigating to an office building. However, during non-work hours, suggested features may include features such as calling a home telephone number or navigating to a restaurant.

In some embodiments, personalized preferences may change depending on the status of the vehicle (e.g., whether the vehicle in on or off, whether the vehicle is in gear, etc). As an example, the data mining module 122 may generate a one set of suggested features for the vehicle when it is in a parked position such as the option to read an electronic book. However, such a feature may not be suggested when the vehicle is in motion.

The adaptive module 124 has function of processing the preference data generated by the data mining module 122.

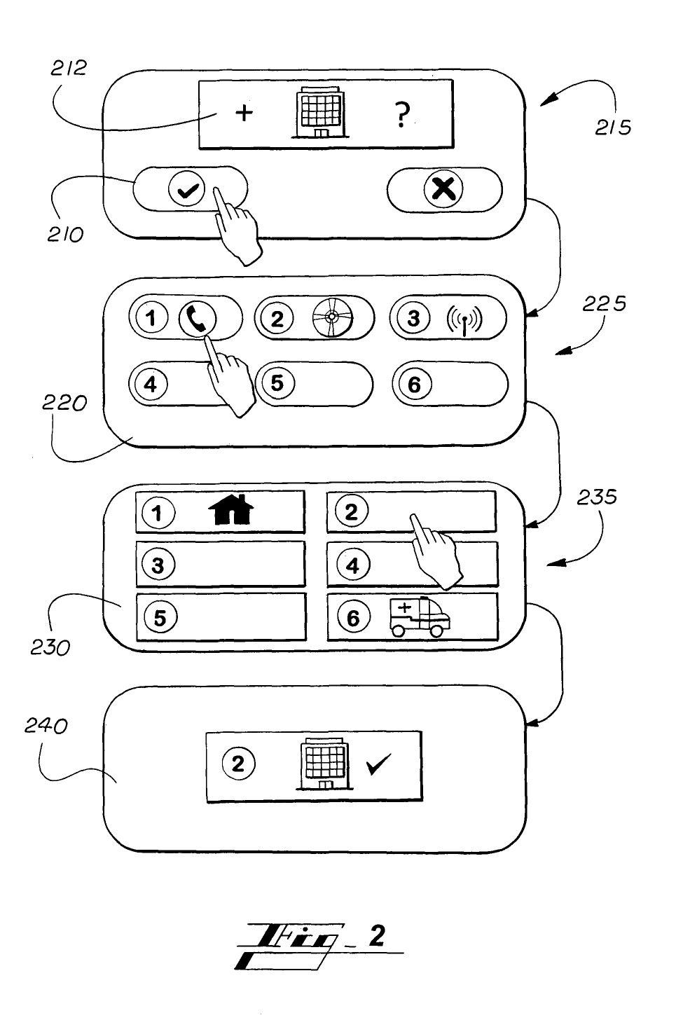

In some embodiments, a suggested feature 212 (shown in FIG. 2 and described more below) is presented by way of the control panel 130 by the adaptive module 124. Information transmitted between the adaptive module 124 and the data mining module 122 occurs via a control signal 125. Information transmitted between the adaptive module 124 and the data mining module 122 may be bidirectional. Information flowing from the data mining module 122 to the adaptive module 124 may include, e.g., features such as the suggested feature 212, derived from the reoccurring data segments identified by the data mining module 122. Information flowing from the adaptive module 124 to the data mining module 122 may include user inputs from the control panel 130, which are received by the adaptive module 124 via the control signal 135.

In one embodiment, user inputs of the adaptive module 124 are prearranged on the control panel 130 when the vehicle is manufactured. Prearranged user inputs may be based on data mining of large-scale user-interactions (e.g., the preset emergency call option number 6 in FIG. 2). As the vehicle is operated, the HMI module 110 and the setting module 120 log user interactions. After the user interacts with the control panel 130 and proximity control 140 for a period of time (e.g., one week), the setting module 120 may initiate a request for human interface that is transmitted to the control panel 130. The request may suggest assignment of frequently used features onto the control panel 130 according to the user's interface history. The user interface history may also be designated for more than one HMI, e.g., multiple operators of the same vehicle.

In another embodiment, user inputs of the adaptive module 124 are initially set by the user using the control panel 130 and/or the proximity control 140. Preferential features are set by the user through interface with the setting module 120 on the control panel 130. Interface with the setting module 120 requests whether a preferred feature should be added onto the control panel 130 and/or the proximity control 140 and where to locate the preferred feature.

Interface with the setting module 120 may be completed through input options including but not limited to speech interface or inputs on the control panel 130 and/or the proximity control 140. For example, on the steering wheel (e.g., press-and-hold SELECT button to accept).

Although the setting module 120 may suggest features, there should be human interaction to accept or decline which features will be added to the control panel 130 and/or the proximity control 140. This human interaction allows both the use-frequency and vehicle operator/passenger preference will be considered to determine the features accessible on both the control panel 130 and the proximity control 140.

The control panel 130 is located in the center stack of the vehicle. The position of the control panel 130 within the center stack may vary from the dashboard to a location proximal to the gear shift or near the center console. The suggested features displayed on the control panel 130 may include text, graphics, textures, or a combination thereof.

Due to its location within the center stack, the stack control may be accessible by both the vehicle operator and passenger. However, as stated above, requiring the vehicle operator to interface reach to the center stack may pose safety concerns. As such, the control panel 130 may be integrated with other the proximity control 140.

The control panel 130 may also be located in areas that are proximal to vehicle operator's hand, such as on the center pad of the steering wheel. The control panel 130 may also be configured to operate in conjunction with an application on a mobile device (e.g., smart phone, tablet, smart watch). The application may be in communication with, for example, a vehicle infotainment system, by way of a wired or wireless connection (e.g., Bluetooth), to project the content onto the control panel 130 or other display device within the vehicle (e.g., dash display screen or head-up display).

The control panel 130 may be configured into different shapes to allow integration with the varying vehicles. For example, the control panel 130 may be a square board, with a certain number of input selections (e.g., buttons).

The control panel 130 may also be configured to be detachable from the center stack of the vehicle to allow portability. Portability may be a desired feature for situation in which an individual user uses more than one vehicle and would prefer to have personalized control options within each vehicle.

In a contemplated embodiment, the panel 130 can be transferred for use in a vehicle that is not owned by the user, such as in a friend's car or a rental car. In another contemplated embodiment, any of the personalized programming and/or data described herein can be transferred, e.g., wirelessly, for implementation and use by the user at a vehicle other than a primary vehicle or vehicle(s) of the user.

In an exemplary embodiment shown in FIG. 2, the control panel 130 has two feature layers. The first layer is a feature display 212, which allows the user to select the desired feature, such as phone call, navigation, music, radio. The second layer is a subfeature display 230, which is the subfeature under the feature display 212. User inputs on the subfeature display 230 may include options such as phone call to specific contacts (when using phone feature), navigation to specific destinations (when using navigation feature), music from specific artists (when using an audio feature—e.g., playing a compact disc). This configuration allows the user to make selection using simplified buttons (e.g., up and down, back and forth, enter buttons) to navigate and select features.

The control panel may have additional layers, which display on the control panel 130. For example, the control panel 130 may include a display layer to suggest personalized features (e.g., suggestion display 210) or a display layer to confirm a selection more or less layers that include in the exemplary embodiment.

In some embodiments, the control panel 130 provides feedback, e.g., audio, visual, or otherwise, after user selects an input option. For example, after selecting the preference to start navigation to a particular destination, audio feedback may announce the navigation has started. As another example, after selecting a particular radio station, a visual indicator may show confirmation of the selection on the control panel 130 in a color.

The control panel 130 communicates with the HMI module 110 and the components of the setting module 120. The control panel 130 maintains bidirectional information flow with the HMI module 110 via the control signal 145, mentioned above. The control signal 145 transmits information such as but not limited initial factory settings provided from the HMI module 110 to the control panel 130. The control signal 145 also transmits information from the control panel 130 to the HMI module 110 such as frequently used applications that may be used utilized by vehicle manufactures in future software designs.

The control panel 130 also maintains bidirectional information flow with the adaptive module 124 via the control signal 135. The control signal 135 transmits information such as user input selections from the control panel 130 to the adaptive module 124. The control signal 135 also transmits information from the adaptive module 124 to the control panel 130, such as suggested feature options, that the user may choose to make a personalized preference on the control panel 130.

Finally, the control panel 130 also maintains unidirectional information flow to the data mining module 122 via a control signal 137. The control signal 137 transmits information such as user input selections on the control panel 130, which is used to suggest preferences via the adaptive module 124. The control signal 137 may transmit information such as but not limited to telephone calls (contacts, dialed numbers, recent calls); navigation (e.g., points of interest, contact addresses, recent destinations, current location); Bluetooth connection (e.g., internet applications); audio options (e.g., AM/FM radio, compact disks, auxiliary); climate controls; and weather information.

In some embodiments, the panel system 100 contains the operator proximity control 140. The proximity control 140 may be connected to the control panel 130 (e.g., hard-wired) to allow the vehicle operator to make selections on the proximity 140 in addition to (or instead of) on the control panel 130. The proximity control 140 is in a position that allows for ease of access to the vehicle operator and prevents the operator from taking his eyes off the road for extended periods of time, e.g., vehicle steering wheel.

The proximity control 140 may include varying types of HMI input options including buttons, knobs, touchscreens, or the like. The input options may include pre-selected options (e.g., up/down arrows) and/or personalized options (e.g., answer/end telephone call).

Similar to the control panel 130, the proximity control 140, may be configured into different shapes to allow integration within many types of vehicle. As an example, the proximity control 140 may include a series of buttons along the steering wheel rim.

### II. SETTING STACK CONTROL FEATURES

### FIG. 2

FIG. 2 illustrates an embodiment for setting personalized controlling features of the panel system 100. A process of setting personalized features includes (1) selecting the whether to add the suggested feature 212 on the suggestion display, (2) selecting the feature location on a feature display 220, (3) selecting the feature location on a subfeature display 230. In some embodiments, the setting will be confirmed on a confirmation display 240.

In operation, at operation 215, using the control panel 130, the adaptive module 124 displays on the suggestion display 210 the suggested feature 212.

In the example shown in FIG. 2, the suggested feature 212 prompts the user to add a telephone number, specifically an office telephone number, to his personalized features.

The suggested feature 212 displayed on the suggestion display 210 results from the data mining module 122, which identifies reoccurring patterns of the panel system 100 user through interface with the control panel 130. Continuing with the aforementioned example, the suggestion to add the office telephone number is a result of the data mining module 122, which has identified that the user has dialed the telephone number on multiple occasions. The data mining module 122 predicts that the vehicle operator may have need to use the telephone number on future occasions. As such, the data mining module 122 transmits, via the control signal 125, the predicted information to the adaptive module 124. The adaptive module 124 uses the predicted information to form a suggested feature 212 for the vehicle operator, which is displayed on the control panel 130.

Once the suggested feature 212 is communicated to the vehicle operator on the control panel 130, the user may select whether he would like to (1) accept or (2) reject the suggested feature 212. If the user is the vehicle operator, he may select his desired response directly from the control panel 130 or from the proximity control 140.

Next, if the user accepts the suggested feature 212 on the suggestion display 210, the control panel 130 will allow the user to select, on the feature display 220, where the suggested feature 212 should be added at operation 225.

The feature display 220 may include any number of input options (e.g., input options 1-6 as seen on the feature display 220. The input options may be any number of options preset by the vehicle manufacturer (e.g., telephone input option 1 seen in on the feature display 220) and personalized input options set by the user (e.g., unassigned input options 4-6 on the feature display 220). For example, if the suggested preference 212 is a telephone number, the user may choose to add the telephone number directly on the feature display 220 (e.g., input option 4 on the feature display 220).

The user may also add a feature to the feature display 220 that is not suggested. For example, if the user would like to have a navigation application displayed on the feature display 220, the user would be able to input the desired input option he would like to have the navigation application occupy (e.g., input option 5 on the feature display 220).

In some embodiments, the control panel 130 may bypass the feature display 220 shown at operation 225 when the interface 122 recognizes the feature. For example, if the suggested feature 212 is to add a telephone number, the control panel 130 will allow the user to add the telephone number directly to the telephone options subfeature display 230 shown in operation 235. Similarly, if the suggested feature 212 is to add a radio station (e.g., input option 3 on the feature display 220), the control panel 130 will allow the user to add the radio station direction to the radio options subfeature display (not shown).

Next, once the vehicle operator selects the feature on the feature display 220, the control panel 130 will allow the user to select, on the subfeature display 230, where the suggested preference 212 should be added at operation 235. In embodiments where the feature display 220 shown at operation 225 is bypassed, the control panel 130 shows the subfeature display 230 in lieu of the feature display.

The subfeature display 230, similar to the feature display 220, may also include any number of input options (e.g., input options 1-6 as seen on the subfeature display 230). The input options may be any number of options preset by the vehicle manufacturer (e.g., emergency telephone input option 6 seen on the subfeature display 230) and personalized input options set by the vehicle driver (e.g., input options 1-5 seen on the subfeature display 230).

Finally, in applicable embodiments, once the suggested feature 212 is added to the feature display 220 at operation 225 or the subfeature display 230 at operation 235, the control panel 130 will confirm the vehicle operator's action on the confirmation display 240. As stated above, information communicated by the control panel 130, including but not limited to the displays 210, 220, 230, and 240, may include, but is not limited to text, graphics, and texture.

### III. RECALLING STACK CONTROL FEATURES

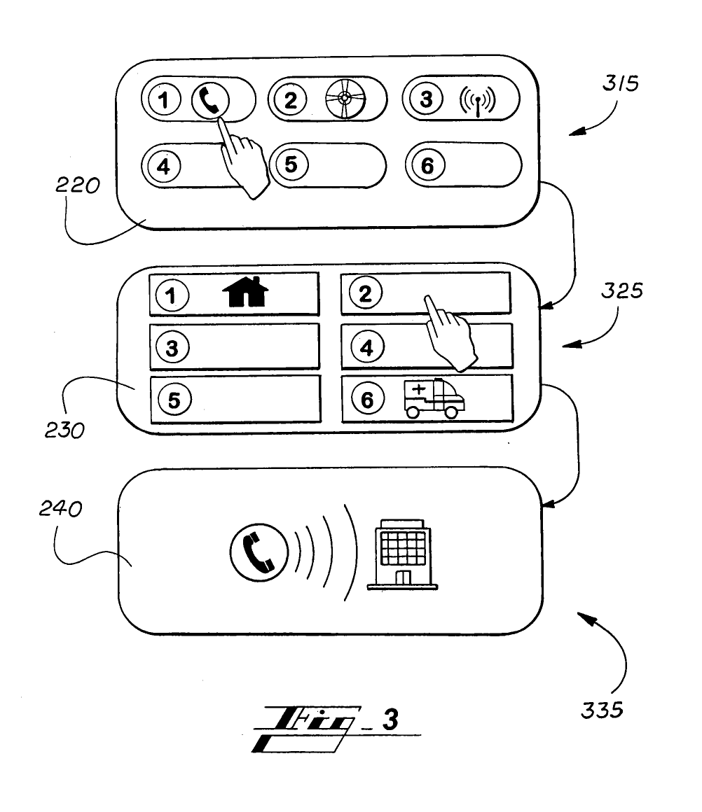

### FIG. 3

FIG. 3 illustrates an embodiment for recalling personalized controlling features of the panel system 100. The process of recalling personalized features includes (1) selecting a desired input option from the feature display 220, and (2) selecting the desired input option from the subfeature display 230. In some embodiments, the action will be confirmation on the confirmation display 240.

First, from the feature display 220, the user may select from any number of input options (e.g., input options 1 to make a telephone call on the feature display 220) at operation 315. The user may select his desired input option directly from the control panel 130 or from the proximity control 140. The input options may be manufacturer preset options and personalized input options as described in association with FIG. 2.

Next, the control panel 130 allows the user to select, on the subfeature display 230, the input option that the user desires to recall at operation 325. Similar to the feature display 220, the input options on the subfeature display 230 may be manufacturer preset options and personalized input options as described above (e.g., input option 2 to call office located on subfeature display 230 in FIG. 3).

Finally, in applicable embodiments, at operation 335, once the input option is selected on the feature display 220, the control panel 130 will confirm the vehicle operator's action on the confirmation display 240. As stated above, information communicated by the control panel 130, including but not limited to the displays 210, 220, 230, and 240, may include text, graphics, and the like. The selection may also be confirmed through sound. For example, to confirm a telephone call is being place, a verbal confirmation may say “calling office.”

### IV. BENEFITS AND ADVANTAGES

Many of the benefits and advantages of the present technology are described herein above. The present section presents in summary some of the benefits of the present technology.

The technology provides vehicle operators with easier and safer access to infotainment applications. In some embodiments, the technology includes a control panel, which is in connection with a proximity control that is easily accessible to the vehicle operator. The proximity control improves driving safety by putting the most commonly used controls in a convenient position for the vehicle operator (e.g., on the steering wheel). The accessibly of commonly used controls allow vehicle operators to keep their eyes on the road and hands on the steering wheel.

The technology also allows reconfiguration of the controls for frequently used applications to provide a high level of personalization. Consumer product personalization has been a growing trend among many industries including automotive. Personalization of vehicle seating positions and mirror positions are among many options available to the consumer. The ability to personalize frequently used applications and features while within a vehicle may help improve customer vehicle satisfaction.

The technology also allows portability of personally configured controls. In one embodiment, the control panel is detachable. Removability allows a user to transfer the control panel to a different vehicle without losing his customized settings.

The technology may be applicable for other controls as well, e.g., advanced safety systems. The technology may allow advanced safety systems such as autonomous or semi-autonomous vehicle applications including adaptive cruise control (ACC), autonomous parking, etc.

### V. CONCLUSION

Various embodiments of the present disclosure are disclosed herein. The disclosed embodiments are merely examples that may be embodied in various and alternative forms, and combinations thereof.

The law does not require and it is economically prohibitive to illustrate and teach every possible embodiment of the present technology. Hence, the above-described embodiments are merely exemplary illustrations of implementations set forth for a clear understanding of the principles of the disclosure.

Variations, modifications, and combinations may be made to the above-described embodiments without departing from the scope of the claims. All such variations, modifications, and combinations are included herein by the scope of this disclosure and the following claims.

What is claimed is:

1. A method, for providing customized infotainment options to a vehicle user, comprising:
receiving, by a system having a processor, using a data mining module of a learning interface, from a control panel, a first control signal including an information data set;
storing, by the system, using the data mining module, the information data set to a memory;
identifying, by the system, using the data mining module, reoccurring data segments of the information data set;
generating, by the system, using the data mining module, a preference data set including the reoccurring data segments;
processing, by the system, using an adaptive module of the learning interface, the preference data set, yielding option data; and
sending, by the system, using the adaptive module, via a second control signal, the option data to the control panel for presentation to the vehicle user.

2. The method of claim 1, further comprising sending, by the system, using the adaptive module, on the control panel an output comprising the preference data set.

3. The method of claim 1, wherein receiving the information data set is repeatedly performed generally continuously with respect to various data sets received during a time in which a vehicle is operated.

4. The method of claim 3, wherein storing the information data set is repeatedly performed generally continuously with respect to various data sets received during the time in which the vehicle is operated.

5. The method of claim 3, wherein identifying the reoccurring data segments is repeatedly performed generally continuously with respect to various data sets received during the time in which the vehicle is operated.

6. The method of claim 1, further comprising receiving, by the system using the data mining module, from a human-machine interface (HMI), a third control signal including a software data set.

7. The method of claim 6, wherein receiving by the data mining module is performed generally continuously with respect to various data sets received during a time in which the vehicle is operated.

8. The method of claim 6, further comprising receiving, by the system, using the adaptive module, from the HMI, the software data set.

9. The method of claim 8, wherein receiving the software data set by the adaptive module is performed generally continuously with respect to various data sets received during a time in which the vehicle is operated.

10. A method, for a personalized vehicle control panel system to provide customized options for implementation within a vehicle, comprising:
receiving, by a system having a processor, using a data mining module of a learning interface, from a control panel, a first control signal including an information data set;
storing, by the system, using the data mining module, the information data set to a memory;
receiving, by the system, using the data mining module, from a human-machine interface (HMI), a second control signal including a software data set;
identifying, by the system, using the data mining module, reoccurring data segments of the information data set and the software data set;
generating, by the system, using the data mining module, a preference data set including the reoccurring data segments;
processing, by the system, using an adaptive module of the learning interface, the preference data set, yielding option data; and
sending, by the system, using the adaptive module, via a third control signal, the option data to the control panel for presentation to the vehicle user.

11. The method of claim 10, further comprising sending, by the adaptive module, on the control panel an output comprising the preference data set.

12. The method of claim 10, wherein receiving by the data mining module is performed generally continuously with respect to various data sets received during a time in which the vehicle is operated.

13. The method of claim 10, wherein storing by the data mining module is performed generally continuously with respect to various data sets received during a time in which the vehicle is operated.

14. The method of claim 10, wherein receiving by the adaptive module is performed generally continuously with respect to various data sets received during a time in which the vehicle is operated.

15. The method of claim 10, wherein receiving by the data mining module and receiving by the adaptive module is performed generally simultaneously with respect to various data sets received during a time in which the vehicle is operated.

16. A computer-readable storage device comprising instructions, including a learning interface, that, when executed by a processor, cause the processor to perform operations, for providing customized infotainment options to a vehicle user, comprising:
receiving, by a system having a processor, using a data mining module of a learning interface, from a control panel, a first control signal including an information data set;
storing, by the system, using the data mining module, the information data set to a memory;
identifying, by the system, using the data mining module, reoccurring data segments of the information data set;
generating, by the system, using the data mining module, a preference data set including the reoccurring data segments;
processing, by the system, using an adaptive module of the learning interface, the preference data set, yielding option data; and
sending, by the system, using the adaptive module, via a second control signal, the option data to the control panel for presentation to the vehicle user.

17. The device of claim 16, further comprising sending, by the system, using the adaptive module, on the control panel an output comprising the preference data set.

18. The device of claim 16, wherein receiving the information data set is repeatedly performed generally continuously with respect to various data sets received during a time in which a vehicle is operated.

19. The device of claim 18, wherein storing the information data set is repeatedly performed generally continuously with respect to various data sets received during the time in which the vehicle is operated.

20. The device of claim 18, wherein identifying the reoccurring data segments is repeatedly performed generally continuously with respect to various data sets received during the time in which the vehicle is operated.

21. The device of claim 16, further comprising receiving, by the system using the data mining module, from a human-machine interface (HMI), a third control signal including a software data set.

22. The device of claim 21, wherein receiving by the data mining module is performed generally continuously with respect to various data sets received during a time in which the vehicle is operated.

23. The device of claim 6, further comprising receiving, by the system, using the adaptive module, from the HMI, the software data set.

24. The device of claim 23, wherein receiving the software data set by the adaptive module is performed generally continuously with respect to various data sets received during a time in which the vehicle is operated.

25. A computer-readable storage device comprising instructions, including a learning interface, that, when executed by a processor, cause the processor to perform operations, for a personalized vehicle control panel system to provide customized options for implementation within a vehicle, comprising:
receiving, using a data mining module of a learning interface, from a control panel, a first control signal including an information data set;
storing, using the data mining module, the information data set to a memory;
receiving, using the data mining module, from a human-machine interface (HMI), a second control signal including a software data set;
identifying, using the data mining module, reoccurring data segments of the information data set and the software data set;
generating, using the data mining module, a preference data set including the reoccurring data segments;
processing, using an adaptive module of the learning interface, the preference data set, yielding option data; and
sending, using the adaptive module, via a third control signal, the option data to the control panel for presentation to the vehicle user.

26. The method of claim 25, further comprising sending, by the adaptive module, on the control panel an output comprising the preference data set.

27. The method of claim 25, wherein receiving by the data mining module is performed generally continuously with respect to various data sets received during a time in which the vehicle is operated.

28. The method of claim 25, wherein storing by the data mining module is performed generally continuously with respect to various data sets received during a time in which the vehicle is operated.

29. The method of claim 25, wherein receiving by the adaptive module is performed generally continuously with respect to various data sets received during a time in which the vehicle is operated.

30. The method of claim 25, wherein receiving by the data mining module and receiving by the adaptive module is performed generally simultaneously with respect to various data sets received during a time in which the vehicle is operated.
